(19) United States
(12) Patent Application Publication
(10) Pub. No.: US 2016/0026977 A1
(43) Pub. Date: Jan. 28, 2016

(54) Calendar Event Scheduling Based on Sensor-Detected Events

(71) Applicant: GOOGLE INC., Mountain View, CA (US)

(72) Inventor: Vijay Umapathy, Sunnyvale, CA (US)

(21) Appl. No.: 14/338,269

(22) Filed: Jul. 22, 2014

(51) Int. Cl. G06Q 10/10

(52) U.S. Cl. CPC G06Q 10/1093

(57) ABSTRACT

A process of scheduling events in a user's electronic calendar executes at a computer system with one or more processors and memory. The memory stores one or more programs configured for execution by the one or more processors. The process creates a calendar item scheduled at a time offset from a triggering event. The triggering event includes receiving one or more predefined signals from distinct sensors. The predefined signals include a first signal from a first sensor that identifies physical motion. The process identifies the occurrence of the triggering event based on receiving the one or more predefined signals from the sensors. The process updates the calendar item to specify a scheduled time that is computed as the time offset from the occurrence of the triggering event. The process notifies the user of the calendar item when the scheduled time is reached.

### TECHNICAL FIELD

The disclosure relates generally to electronic calendars, and more specifically to scheduling calendar items based on signals from sensors.

### BACKGROUND

Electronic calendars are increasingly used to organize people's lives. Such calendars are accessed from both desktop computers and portable computing devices (e.g., laptop computers, mobile phones, personal digital assistants (PDAs), tablet computers, and wearable computers).

Users of calendar applications may create items in their calendars to denote a commitment of some duration of time to a given activity or engagement with another person. Some of these items cannot accurately be scheduled at a fixed time because they are relative to some other event. For example, a user may want to commit to a morning exercise routine that begins 30 minutes after the user wakes up.

### SUMMARY

Disclosed implementations address the above deficiencies and other problems associated with scheduling electronic calendar items that are based on the dynamic occurrence of real world events. Disclosed implementations allows a user to schedule items in a calendar that are not at a fixed time but are relative to events detected by sensors (e.g., sensors on a mobile device).

Some implementations include three major components. A first component is a calendar application, which includes a user interface that a user uses to create items that represent time commitments. A second component is a trigger event daemon, which receives event data from sensor-enabled devices, contains business logic to combine these event signals into user-understandable events (e.g., a “wake up” event), and communicates with the calendar's application programming interface (API) to modify calendar items based on the designated triggers. In some implementations, the trigger event daemon is cloud-based. A third component is a set of one or more networked devices equipped with sensors that can publish sensor events. Sensor events include: users entering a designated location; a device being physically moved; or motion being detected in a room of a household. The sensor events/signals are sent to the trigger event daemon.

The following example illustrates some of the disclosed features. First, a user creates a triggered item in a calendar, such as an event titled “Morning Workout.” This item is scheduled to start “10 minutes after I wake up.” The user identifies “waking up” as an event that is detected by an internet-connected device, such as the user's mobile phone. For example, a user may define a WAKE_UP event in a business logic layer within the trigger event daemon to consist of a combination of three signals: a signal from a system clock indicating that the time is between 6:00 AM and 8:00 AM; a signal from a GPS sensor indicating that the user is at a home location; and a signal from an accelerometer on a mobile device indicating that the user just moved the device N times in the last 60 seconds (e.g., N=5). The calendar application configures the trigger event daemon to subscribe to WAKE_UP events. Later, when the WAKE_UP trigger fires (due to this combination of signals being detected by the trigger event daemon) the trigger event daemon uses the calendar application's API to update the actual start time of the Morning Workout item to be at a fixed time (e.g., 10 minutes after WAKE_UP at 7:15 AM, which is 7:25 AM). At the scheduled time (e.g., 7:25), the electronic calendar notifies the user of the scheduled item. In some implementations, the user is notified at a predefined period before the scheduled time (e.g., five minutes beforehand).

In some implementations, the trigger event daemon runs in the background on the user's mobile device. In some instances, after an item is scheduled at a fixed time (or rescheduled), the calendar processes any additional updates to the user's calendar. For example, items that now conflict with the user's morning workout at 7:25 may need to be rescheduled. When a user accesses a calendar from multiple devices, the calendar user interface on each of the user's devices is updated to reflect the new schedule.

Unlike traditional calendaring systems, some disclosed implementations take advantage of floating triggers that can be defined by an arbitrary number of networked devices capable of detecting real-world events such as user body movement, changes in a user's household, a user's presence at a location, and more.

One advantage of the disclosed implementations for creating calendar items is that it takes into account the right context for doing certain things relative to events that are not purely time-based (e.g., waking up in the morning). Disclosed implementations also allow a calendar to react to changes in a user's schedule based on when events actually occur, such as arriving at a location.

In some implementations, the trigger event daemon runs on a server (e.g., a calendar server), and may process events for many different users. The trigger event daemon receives signals from sensors on many different devices. In other implementations, the trigger event daemon is a program that runs locally on a single device or as part of the calendar application.

In accordance with some implementations, a method executes at a computer system with one or more processors and memory. The memory stores one or more programs configured for execution by the one or more processors. The process creates a calendar item scheduled at a time offset from a triggering event. The triggering event includes receiving one or more predefined signals from distinct sensors. In some instances, the triggering event includes receiving a plurality of predefined signals from a plurality of distinct sensors. In some implementations, the sensors include clocks, accelerometers, motion sensors, and/or GPS sensors. In some implementations, the sensors can detect entry by a user into a predefined geographical region or arrival at a predefined location (e.g., using GPS information to identify arrival at an office location). The predefined signals include a first signal from a first sensor that identifies physical motion. In some instances, the first signal indicates repetition of physical motion multiple times within a designated span of time (e.g., moving a mobile phone 4 times within a minute). In some implementations, one or more of the sensors are components of a mobile device associated with a user (e.g., a mobile phone or tablet computer). The process identifies the occurrence of the triggering event based on receiving the one or more predefined signals from the sensors. The process updates the calendar item to specify a scheduled time that is computed as the time offset from the occurrence of the triggering event. The process notifies the user of the calendar item when the scheduled time is reached.

### BRIEF DESCRIPTION OF THE DRAWINGS

For a better understanding of the aforementioned implementations of the invention as well as additional implementations thereof, reference should be made to the Description of Implementations below, in conjunction with the following drawings in which like reference numerals refer to corresponding parts throughout the figures.

FIG. 1 illustrates a context in which some implementations operate.

FIG. 2 is a block diagram of a client device according to some implementations.

FIG. 3 is a block diagram of a server according to some implementations.

FIGS. 4 and 5 provide skeletal data structures that may be used to store calendar data and event data in accordance with some implementations.

FIGS. 6A and 6B provide a flowchart of a process, performed at a computer system, for scheduling items in a user's electronic calendar according to some implementations.

Reference will now be made in detail to implementations, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details.

### DESCRIPTION OF IMPLEMENTATIONS

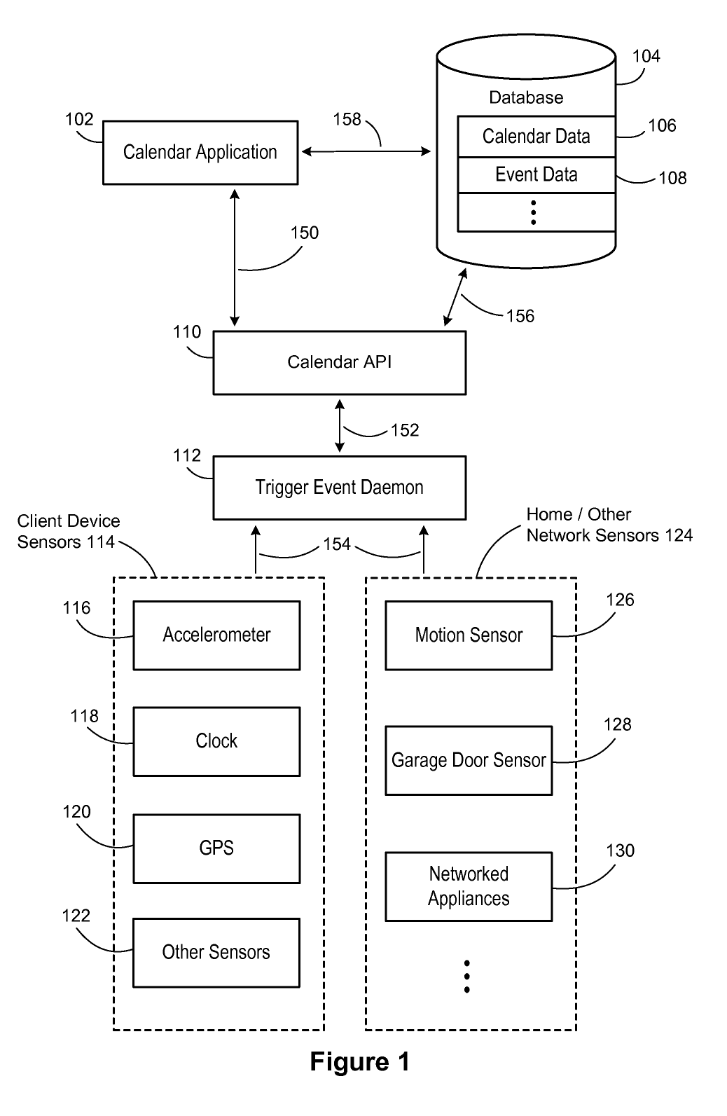

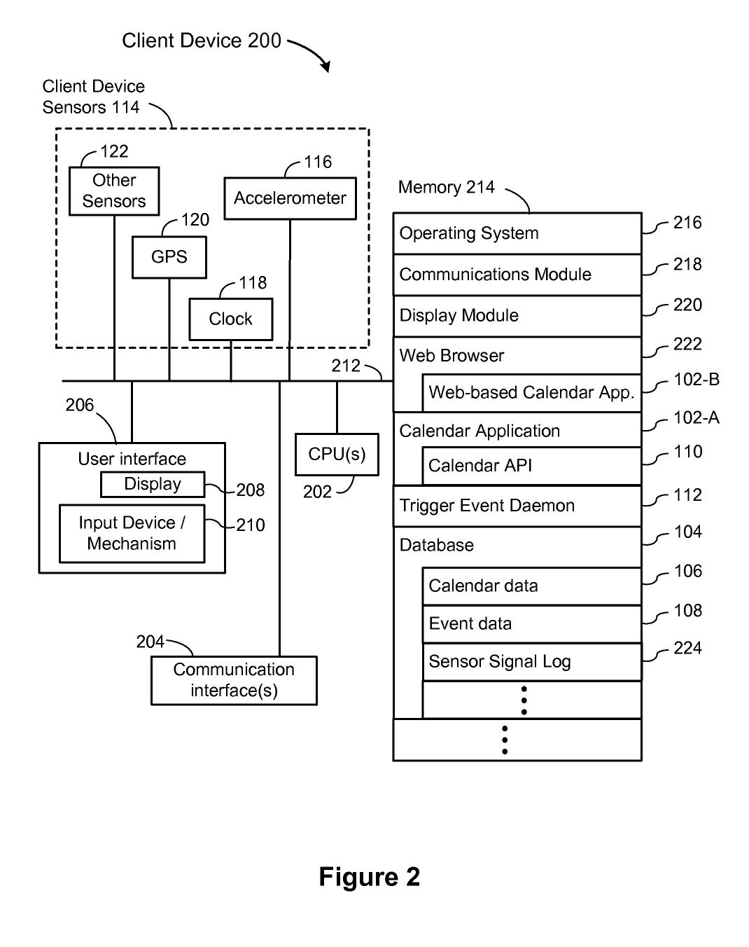

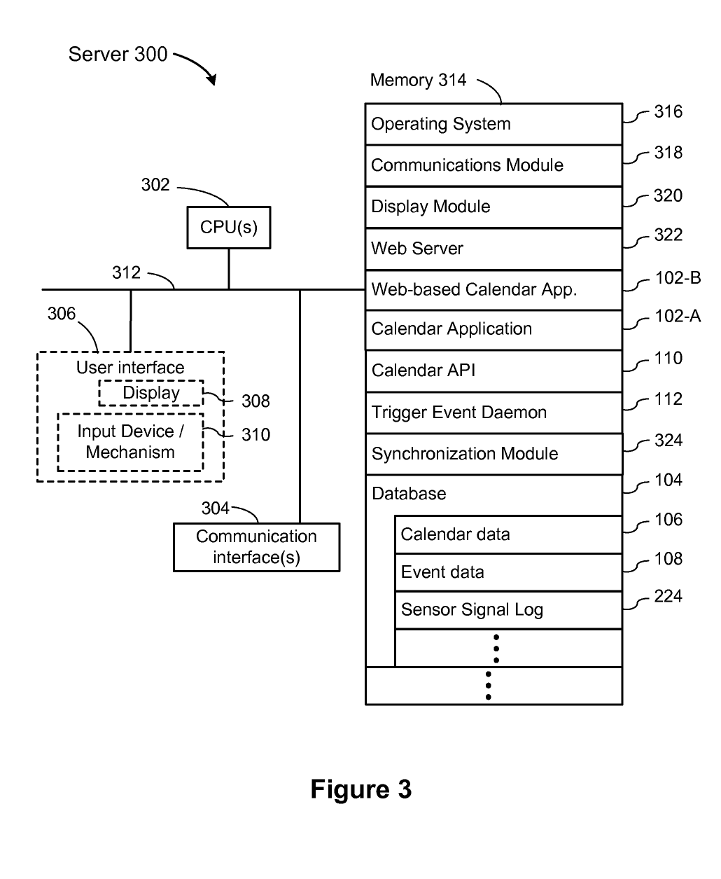

FIG. 1 is a block diagram that illustrates the major components of some implementations. As described below with respect to FIGS. 2 and 3, some of the components may be implemented on either a client device 200 or a server 300. Disclosed implementations provide a calendar application 102, which may be a web-based calendar application 102-B running in a web browser 222 or a desktop calendar application 102-A, which runs independently of a web browser. Some implementations support both types of calendar applications. In some implementations, the calendar application 102 is an integrated part of an email application.

The calendar application 102 includes a user interface, which is not depicted in FIG. 1. In addition to the visual user interface, implementations provide an application programming interface (API) 110, which enables the calendar application 102 to interact with other programs (standard or custom). In some implementations, the calendar application interacts with a trigger event daemon 112 through the API 110, as described in more detail below. The trigger event daemon 112 also receives sensor signals 154 from various client device sensors 114 (e.g., sensors included with a Smart phone) and/or from other home sensors 124. Implementations typically store calendar data 106 and event data 108 in a database 104. Data is sent to and received from the calendar application 102 and the calendar API 110. In some implementations, the database 104 is a relational database, such as an SQL database. In other implementations, the database 104 is structured data stored as files on a file server. Some implementations include two or more databases. The database 104 may be stored as a CSV file, an XML file, a flat file, or in other formats.

As illustrated in FIG. 1, the client device sensors 114 on a client device 200 may include an accelerometer 116, a clock 118, a GPS system 120, and/or other sensors 122. Each of the sensors 114 is able to provide sensor signals 154 to the trigger event daemon 112. Each type of sensor 114 provides specific sensor signals 154. For example, an accelerometer 116 measures acceleration, which can be used to identify motion. A GPS system provides global positioning information, which may be used to identify the location of the device 200 (and thus the user of the device) relative to known regions or locations (e.g., a person's home or office).

The trigger event daemon 112 can also receive sensor signals 154 from home or network sensors 124. The home sensors 124 may include motion sensors 126 or other sensors in a home security system (e.g., sensors that detect whether doors or windows are open). In some instances, the home sensors include a garage door sensor 128 that indicates whether the garage door is open. Some implementations support sensors 124 on networked home appliances 130, such as refrigerators, coffee makers, or tea kettles. These networked home appliances 130 can provide status information (e.g., is the refrigerator door open or is the coffee done).

Some implementations support other network sensors 124 outside of a home as long as their network connections allow communication with the trigger event daemon 112. For example, some implementations support web cams. In some implementations, the other network sensors 124 includes signals received from third party sources, such as a news feed.

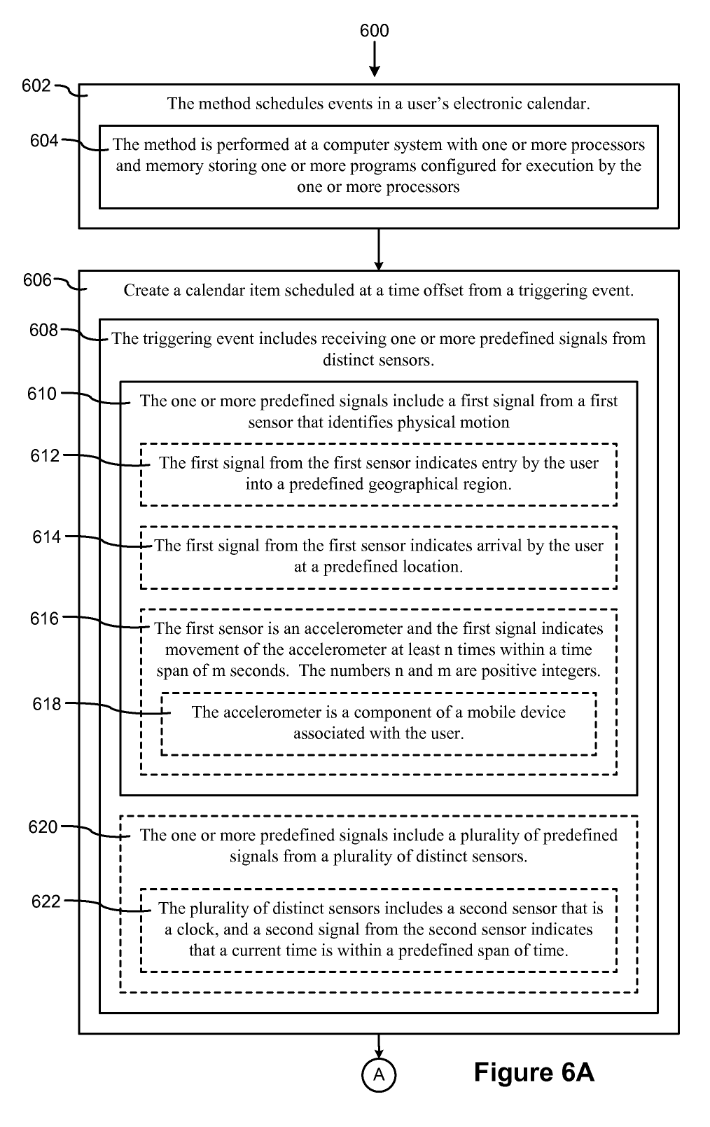

In operation, a user accesses the calendar application 102, and inserts a new calendar item. Rather than scheduling the item at a specific date and time, the item is scheduled at an offset from an unscheduled event. The calendar item and information about the triggering event are sent (158) to the database 104 for storage in the calendar data 106 and event data 108. The calendar application also communicates (150) the triggering event information through the calendar API to (152) the trigger event daemon. The trigger event daemon tracks the definition of each triggering event. In particular, a triggering event includes appropriate sensor signals from one or more of the client device sensors 114 or home sensors 124. Typically, implementations support various combinations of sensor signals. For example, a triggering event may require signal 1 and (signal 2 or signal 3). This is described in more detail below with respect to FIG. 5.

When the trigger event daemon detects that it has received all of the sensor signals 154 required for a triggering event, the trigger event daemon 112 sends (152) the trigger event information (e.g., the event ID 502) to the calendar API, which forwards (150) the information to the calendar application 102 and/or to (156) the database 104. In some implementations, the calendar API 110 uses the information from the triggering event to update the calendar item. In particular, the calendar item is now scheduled on a specific date and time rather than as an offset. The specific date and time are computed as the offset from the time of the triggering event.

In some implementations, a single calendar for a user is shared by multiple devices (e.g., a desktop computer, a tablet computer, and a Smart phone). In this case, when the triggering event is detected and updated to the database, the calendar is updated (158) on each of the devices. In some implementations, updating all of the copies of the user's calendar is performed by a synchronization module 324. For example, in some implementations, there is a master copy of a user's calendar data stored in a database 104 on a server 300, and as changes are received from any of the copies, the synchronization module 324 on the server 300 propagates the changes to all of the copies.

FIG. 2 is a block diagram illustrating a client device 200 that a user may use to access a calendar application 102. Client devices include desktop computers, laptop computers, tablet computers, Smart phones, PDA's, and other devices that host a calendar application 102 and have access to one or more sensors 114 for identifying the occurrence of various events. A client device 200 is commonly used by a single user (e.g., a Smart phone), or shared by a small number of users (e.g., a home desktop computer). A client device 200 is an example of a computer system.

A client device 200 typically includes one or more processing units (CPU's) 202 for executing modules, programs, or instructions stored in memory 214 and thereby performing processing operations; one or more network or other communications interfaces 204; memory 214; and one or more communication buses 212 for interconnecting these components. The communication buses 212 may include circuitry (sometimes called a chipset) that interconnects and controls communications between system components. A client device 200 includes a user interface 206 comprising a display device 208 and one or more input devices or mechanisms 210. In some implementations, the input device/mechanism includes a keyboard and a mouse; in some implementations, the input device/mechanism includes a “soft” keyboard, which is displayed as needed on the display device 208, enabling a user to “press keys” that appear on the display 208.

A client device 200 typically includes one or more client device sensors 114. In some implementations, the client device 200 includes an accelerometer 116, which detects motion (acceleration) of the client device 200. An accelerometer 116 is generally able to detect changes in speed as well as changes in direction of movement. The accelerometer 116 quantifies the amount of acceleration and transmits a signal to other components of the client device (e.g., to a trigger event daemon 112 or to a communications module 218). A client device 200 typically includes a clock 118, which is a sensor that provides time information. The some implementations, a local clock 118 on the client device 200 is periodically updated from an external source.

Some client devices include a GPS system 120, which is a sensor that provides location information (e.g., longitude, latitude, and altitude). Note that a GPS system can also be used as a simple motion detector by recognizing when the location changes. Some client devices 200 include other sensors 122 as well, such as a microphone, video sensor, or compass. Each of the client device sensors 114 can detect certain activity and provide electronic signals that quantify or measure the activity in some way.

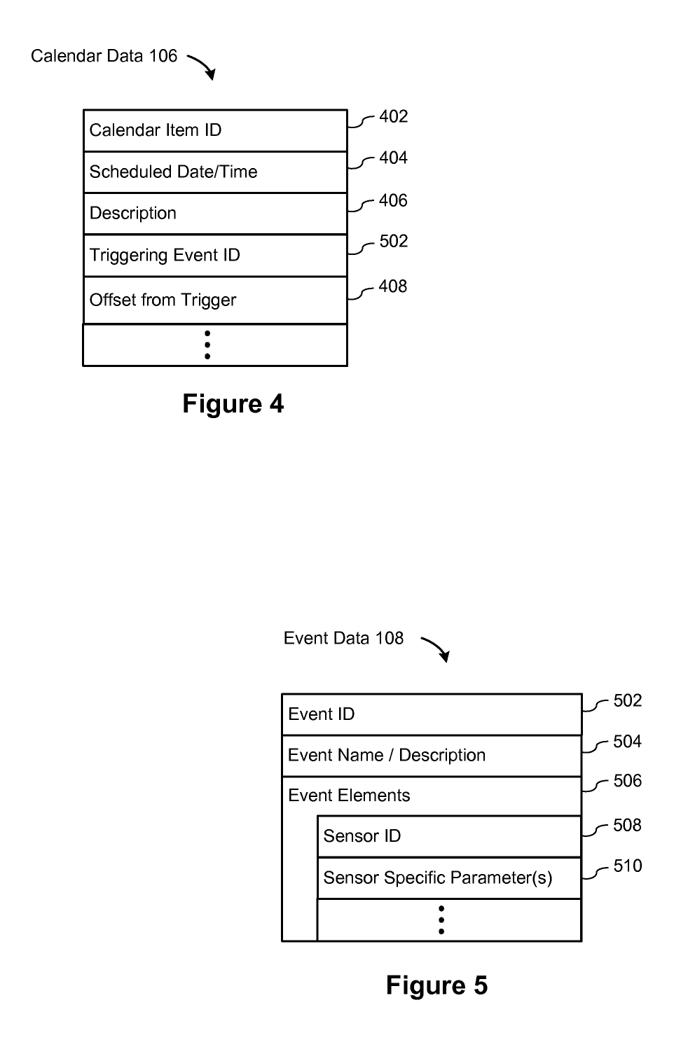

In some implementations, the memory 214 includes high-speed random access memory, such as DRAM, SRAM, DDR RAM or other random access solid state memory devices. In some implementations, memory 214 includes non-volatile memory, such as one or more magnetic disk storage devices, optical disk storage devices, flash memory devices, or other non-volatile solid state storage devices. In some implementations, the memory 214 includes one or more storage devices remotely located from the CPU(s) 202. The memory 214, or alternately the non-volatile memory device(s) within memory 214, comprises a non-transitory computer readable storage medium. In some implementations, the memory 214, or the computer readable storage medium of memory 214, stores the following programs, modules, and data structures, or a subset thereof:
an operating system 216, which includes procedures for handling various basic system services and for performing hardware dependent tasks;
a communications module 218, which is used for connecting the client device 200 to other computers and devices via the one or more communication network interfaces 204 (wired or wireless) and one or more communication networks, such as the Internet, other wide area networks, local area networks, metropolitan area networks, and so on;
a display module 220, which receives input from the one or more input devices 210, and generates user interface elements for display on the display device 208;
a web browser 222, which enables a user to communicate over a network (such as the Internet) with remote computers or devices, such as a server 300. In some instances, a web-based calendar application 102-B runs within the browser to provide the user access to an electronic calendar;
a calendar application 102-A, which provides a user access to an electronic calendar, but does not run within a web browser 222. Some implementations provide both web-based versions 102-B and non-web-based versions 102-A of a calendar application 102, typically with similar functionality. The calendar application enables a user to create, update, or delete calendar items. Some calendar items are scheduled for a specific date and time (e.g., a meeting with colleagues), but other calendar items are scheduled as an offset from some defined event (e.g., waking up in the morning or arriving at the office after a long commute). In some implementations, the calendar application includes an API 110, which is used to send and receive information from other programs or processes (e.g., communication with a trigger event daemon 112);
a trigger event daemon 112, which receives definitions of triggering events, and identifies when triggering events have occurred based on receiving signals from one or more sensors (client device sensors 114 and/or home sensors 124). When a triggering event occurs, the trigger event daemon 112 sends that information to the calendar application 102 and/or the database 104, typically using the calendar API 110; and
a database 104, which includes calendar data 106 (e.g., all of the items in the user's calendar), event data 108 (e.g., what sensor signals are required to constitute a specific event), as well as a sensor signal log 224. In some implementations, the sensor signal log 224 tracks each of the sensor signals that are received, including an identifier of the sensor (e.g., sensor ID 508) as well as data indicating the sensor reading. In some instances, the sensor can output a continuous range of values (e.g., from an accelerometer 116 or a GPS system 120), but in other instances the signal is just an on/off value (e.g., from a motion sensor). The calendar data 106 and event data 108 are described in more detail below with respect to FIGS. 4 and 5.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 214 may store a subset of the modules and data structures identified above. Furthermore, the memory 214 may store additional modules or data structures not described above.

Although FIG. 2 shows a client device 200, FIG. 2 is intended more as a functional description of the various features that may be present rather than as a structural schematic of the implementations described herein. In practice, and as recognized by those of ordinary skill in the art, items shown separately could be combined and some items could be separated.

FIG. 3 is a block diagram illustrating a server 300 that provides a calendar application 102 for users. In some implementations, multiple servers 300 are grouped together as a server system. A typical server system includes many individual servers 300, which may be dozens or hundreds. A server 300 (or server system) is an example of a computer system. A server 300 typically includes one or more processing units (CPU's) 302 for executing modules, programs, or instructions stored in the memory 314 and thereby performing processing operations; one or more network or other communications interfaces 304; memory 314; and one or more communication buses 312 for interconnecting these components. The communication buses 312 may include circuitry (sometimes called a chipset) that interconnects and controls communications between system components. In some implementations, a server 300 includes a user interface 306, which may include a display device 308 and one or more input devices 310, such as a keyboard and a mouse.

In some implementations, the memory 314 includes high-speed random access memory, such as DRAM, SRAM, DDR RAM or other random access solid state memory devices. In some implementations, the memory 314 includes non-volatile memory, such as one or more magnetic disk storage devices, optical disk storage devices, flash memory devices, or other non-volatile solid state storage devices. In some implementations, the memory 314 includes one or more storage devices remotely located from the CPU(s) 302. The memory 314, or alternately the non-volatile memory device(s) within memory 314, comprises a non-transitory computer readable storage medium. In some implementations, the memory 314, or the computer readable storage medium of memory 314, stores the following programs, modules, and data structures, or a subset thereof:
an operating system 316, which includes procedures for handling various basic system services and for performing hardware dependent tasks;
a communications module 318, which is used for connecting the server 300 to other computers via the one or more communication network interfaces 304 (wired or wireless), communication networks, such as the Internet, other wide area networks, local area networks, metropolitan area networks, and so on;
a display module 320, which receives input from one or more input devices 310, and generates user interface elements for display on a display device 308;
a web server 322, which receives requests (e.g., from client devices 200) and provides web pages or other resources in response to the requests;
a web-based calendar application 102-B, which is provided to a client device 200 as needed. The relevant web pages are transmitted to the client device 200 when requested;
a calendar application 102-A, which may be downloaded to a client device 200. Typically, the entire calendar application 102-A is downloaded from the server 300 and installed on a client device 200, at which point the application 102-A runs locally on the client device 200;
a calendar API 110, as described above with respect to the client device 200;
a trigger event daemon 112, as described above with respect to FIGS. 1 and 2;
a synchronization module 324, which maintains consistent views of a user's calendar when the same calendar is accessed from multiple devices. For example, a user may enter a new calendar item using the calendar application 102-A on a desktop computer. A few minutes later, the user departs from the location where the desktop computer is located, and accesses the same calendar using the web-based calendar application 102-B on a mobile device. In the interim, the synchronization module 324 received the update from the desktop computer and updated the database 104 on the server. In some implementations, if the web-based calendar application 102-B was running at the time the new calendar item was added, the synchronization module pushes out the calendar update. If the web based calendar application 102-B was not running on the mobile device, the current calendar information is retrieved from the database 104 when the user starts the application 102-B, thereby retrieving the latest calendar data;
one or more databases 104, which store various data, including calendar data 106, event data 108, and sensor signal log 224. The data stored in the database 104 is described above with respect to FIG. 2, and below with respect to FIGS. 4 and 5.

Each of the above identified elements in FIG. 3 may be stored in one or more of the previously mentioned memory devices. Each executable program, module, or procedure corresponds to a set of instructions for performing a function described above. The above identified modules or programs (i.e., sets of instructions) need not be implemented as separate software programs, procedures or modules, and thus various subsets of these modules may be combined or otherwise re-arranged in various implementations. In some implementations, the memory 314 may store a subset of the modules and data structures identified above. Furthermore, the memory 314 may store additional modules or data structures not described above.

Although FIG. 3 illustrates a server 300, FIG. 3 is intended more as functional illustration of the various features that may be present in a set of one or more servers rather than as a structural schematic of the implementations described herein. In practice, and as recognized by those of ordinary skill in the art, items shown separately could be combined and some items could be separated. The actual number of servers used to implement these features, and how features are allocated among them, will vary from one implementation to another, and may depend in part on the amount of data traffic that the system must handle during peak usage periods as well as during average usage periods.

FIGS. 2 and 3 illustrate various ways that the calendar functionality may be distributed across one or more computer systems. For example, in some implementations, all of the calendar functionality is performed by the client device 200. In these implementations, the calendar application 102-A, the calendar API 110, the trigger event daemon 112, and the database 104 all reside on the client device 200. In this implementation, all of the calendar functionality occurs on the client device 200, but the client device may receive sensor signals from external sensors 124.

In other implementations, the client device runs a web-based calendar application 102-B, but the remainder of the functionality is performed by a server 300. In these implementations, when the client device sensors 114 are used, they transmit signals to the server 300 (e.g., using the communications module 218). In some of these implementations, the client device 200 includes a calendar sensor application (not shown in FIG. 2), which tracks the relevant sensors and forwards the relevant sensor signals to the server 300.

In some implementations, the components illustrated in FIG. 3 are distributed across multiple distinct servers 300. For example, some implementations include:
a group of servers 300 to operate as web servers 322;
a group of servers 300 to act as application servers to provide the web based calendar application 102-B or for downloading the calendar application 102-A;
a group of servers 300 to provide the calendar API 110;
a group of servers 300 to provide the trigger event daemon 112;
a group of servers 300 to provide synchronization functionality 324; and
a group of servers 300 to host one or more databases 104.

The calendar functionality as described herein may be allocated between the client device 200 and one or more servers 300 in various ways.

FIG. 4 provides a skeletal data structure for calendar data 106 according to some implementations. The calendar data includes a set of calendar items, each item representing a single entry in the calendar. Each calendar item is typically assigned a unique calendar item ID 402, which identifies the item. Each calendar item typically includes a description 406, which is usually user-defined and short. A calendar item may have a scheduled date and time 404, which is the most common case. For example, a calendar item may be for a “Sales Meeting” at 2:00 PM EDT.

In some instances, a calendar item may be scheduled at an offset from some triggering event, in which case the scheduled date/time is initially blank or NULL. In this case, the user defines the triggering event, which is identified by a triggering event ID 502 (and described below with respect to FIG. 5). In addition, the user specifies the offset 408, which is the amount of time between the triggering event and when the calendar item is to be scheduled. For example, the offset 408 may be 10 minutes or an hour. In some instances, the offset may be longer, depending on the calendar item and the triggering event. When the triggering event occurs, the scheduled date/time 404 is updated using the offset 408 from the actual time of the triggering event.

FIG. 5 provides a skeletal data structure for event data 108 according to some implementations. For each event, the event data 108 specifies a set of sensor signal data that is required. The event data essentially provides a precise definition of what constitutes the event. Each event is identified by a unique event ID 502, and may include an event name or description 504. For example, a “wake up” event or an “office arrival” event.

Each event is defined based on signals from one or more sensors. Each of these is an element 506 of the event. Each event element 506 corresponds to a unique sensor, which is identified by a sensor ID 508. In addition, each event element includes sensor specific parameters 510 that identify what signal values are required.

For example, consider a “wake up” event that has three elements 506. The first element corresponds to the clock sensor, and the parameters 510 are that the time is between 6:00 AM and 7:00 AM. The second element is based on location. The client device 200 has a GPS sensor 120, and the data from the GPS (longitude and latitude) is compared to the user's home location. The parameters 510 for the GPS include both the longitude and latitude of home and a maximum deviation (e.g., at most 50 feet for each dimension). Finally, the third element is based on the accelerometer, which detects motion of the client device 200 after the user wakes up. The parameters 510 may specify the amount of movement, or the number of movements within a specific interval of time.

Once the event is triggered, the corresponding calendar item is updated with a specific time, and the trigger condition is deactivated. This prevents retriggering calendar updates after the initial triggering condition is detected. For example, in the above scenario, the “wake up” event triggers once, but does not trigger repeatedly between 6:00 and 7:00 as the user moves around at home.

In some implementations, each of the event elements must occur in order for the event to trigger. This essentially places an “AND” between each of the elements. Some implementations provide for more complex Boolean expressions with each of the event elements, which may include AND, OR, and parentheses. Some implementations specifically include repetition in the definition of each event element, with the default being 1. For example, a user may specify the number of repetitions of a sensor signal within a designated span of time.

Note that the event data 108 specifies what sensor signals are required in order to constitute an event. Historical data of the sensor signals actually received may be stored in a sensor signal log 224.

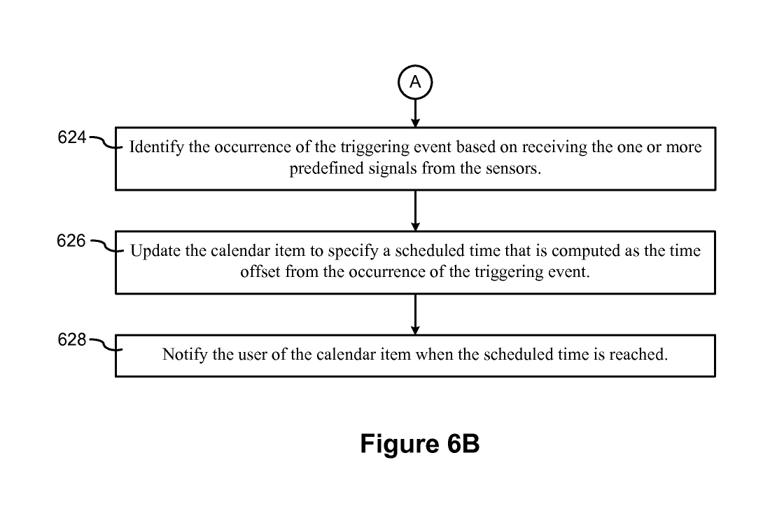

FIGS. 6A and 6B provide a flowchart of a process 600, performed (604) at a computer system, for scheduling (602) items in a user's electronic calendar according to some implementations. The method is performed (604) at a computer system with one or more processors and memory. The memory stores (604) one or more programs configured for execution by the one or more processors.

A user creates (606) a calendar item scheduled at a time offset from a triggering event. The triggering event includes (608) receiving one or more predefined signals from distinct sensors. As illustrated above in FIGS. 1-3, the sensors may be components of a client device 200, may be sensors associated with a home, or may be other types of networked sensors that can provide signals to other devices. The one or more predefined signals include (610) a first signal from a first sensor that identifies physical motion. For example, the first sensor may be an accelerometer 116, a GPS unit 120, or a motion sensor 126.

In some instances, the first signal from the first sensor indicates (612) entry by the user into a predefined geographical region. For example, a GPS sensor 120 may provide signals indicating the location of a user's mobile device (and thereby the location of the user), and the location can be compared to a defined geographical region. A geographical region may be small (e.g., a region representing an office building or a mall), or may be large (e.g., a city). In some instances, the first signal from the first sensor indicates (614) arrival by the user at a predefined location (e.g., arriving at home, arriving at an office, or arriving at a restaurant).

In some instances, the first sensor is (616) an accelerometer and the first signal indicates (616) movement of the accelerometer at least n times within a time span of m seconds. The numbers n and m are positive integers. In some instances, the accelerometer is a component of a mobile device 200 associated with the user. Choosing n greater than 1 can reduce the chance of triggering an accidental incorrect event. For example, the previously described “wake up” event includes movement of a user's client device. If a single movement of the device were enough to trigger a “wake up” event, it could trigger accidentally if a pet knocked the client device off of a nightstand. Similarly, a GPS system 120 on a client device may provide inconsistent readings, even when still, which could incorrectly suggest movement. Requiring multiple movement readings can avoid false positive events.

In some instances, the one or more predefined signals include (620) a plurality of predefined signals from a plurality of distinct sensors. For example, a real world event may be associated with multiple distinct sensor readings instead of a single reading. In some instances, the plurality of distinct sensors includes (622) a second sensor that is a clock, and a second signal from the second sensor (the clock) indicates (622) that a current time is within a predefined span of time. For example, the current time is between 8:00 AM and 9:00 AM local time. In some instances, the second sensor is a clock, and the signal indicates that the current time is at or past a designated time.

The process identifies (624) the occurrence of the triggering event based on receiving the one or more predefined signals from the sensors. In some instances, a sensor pushes data out (e.g., transmitting to the trigger event daemon). In some instances, the trigger event daemon pulls data from a sensor as appropriate. Some sensors are designed for only one mode of operation (i.e., only push or only pull), but other sensors can operate in either mode. For example, a clock sensor may work in a pull mode, with the trigger event daemon checking the clock sensor when the other triggering event elements are satisfied.

When the triggering event is identified, the process 600 updates (626) the calendar item to specify a scheduled time that is computed as the time offset from the occurrence of the triggering event. For example, if the triggering event occurs at 9:18 AM, and the offset is 15 minutes, the calendar item is scheduled for 9:33 AM. In some implementations, the scheduled times can be rounded (e.g., rounded up to the nearest 5 minutes or the nearest 15 minutes).

When the scheduled time is reached (which may be the exact scheduled time or a designated period of time beforehand), the process 600 notifies (628) the user of the calendar item.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises,” “comprising,” “includes,” and “including,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations described herein were chosen and described in order to best explain the principles of the invention and its practical applications, to thereby enable others skilled in the art to best utilize the invention and various implementations with various modifications as are suited to the particular use contemplated.

What is claimed is:

1. A method of scheduling events in a user's electronic calendar, comprising:
at a computer system with one or more processors and memory storing one or more programs configured for execution by the one or more processors:
creating a calendar item scheduled at a time offset from a triggering event, wherein the triggering event comprises receiving one or more predefined signals from distinct sensors, including a first signal from a first sensor that identifies physical motion;
identifying the occurrence of the triggering event based on receiving the one or more predefined signals from the sensors;
updating the calendar item to specify a scheduled time that is computed as the time offset from the occurrence of the triggering event; and
notifying the user of the calendar item when the scheduled time is reached.

2. The method of claim 1, wherein the one or more predefined signals comprise a plurality of predefined signals from a plurality of distinct sensors.

3. The method of claim 2, wherein the plurality of distinct sensors includes a second sensor comprising a clock, and wherein a second signal from the second sensor indicates that a current time is within a predefined span of time.

4. The method of claim 1, wherein the first signal from the first sensor indicates entry by the user into a predefined geographical region.

5. The method of claim 1, wherein the first signal from the first sensor indicates arrival by the user at a predefined location.

6. The method of claim 1, wherein the first sensor is an accelerometer and the first signal indicates movement of the accelerometer at least n times within a time span of m seconds, wherein n and m are positive integers.

7. The method of claim 6, wherein the accelerometer is a component of a mobile device associated with the user.

8. A computer system for scheduling events in a user's electronic calendar, comprising:
one or more processors;
memory; and
one or more programs stored in the memory configured for execution by the one or more processors, the one or more programs comprising instructions for:
creating a calendar item scheduled at a time offset from a triggering event, wherein the triggering event comprises receiving one or more predefined signals from distinct sensors, including a first signal from a first sensor that identifies physical motion;
identifying the occurrence of the triggering event based on receiving the one or more predefined signals from the sensors;
updating the calendar item to specify a scheduled time that is computed as the time offset from the occurrence of the triggering event; and
notifying the user of the calendar item when the scheduled time is reached.

9. The computer system of claim 8, wherein the one or more predefined signals comprise a plurality of predefined signals from a plurality of distinct sensors.

10. The computer system of claim 9, wherein the plurality of distinct sensors includes a second sensor comprising a clock, and wherein a second signal from the second sensor indicates that a current time is within a predefined span of time.

11. The computer system of claim 8, wherein the first signal from the first sensor indicates entry by the user into a predefined geographical region.

12. The computer system of claim 8, wherein the first signal from the first sensor indicates arrival by the user at a predefined location.

13. The computer system of claim 8, wherein the first sensor is an accelerometer and the first signal indicates movement of the accelerometer at least n times within a time span of m seconds, wherein n and m are positive integers.

14. The computer system of claim 13, wherein the accelerometer is a component of a mobile device associated with the user.

15. A non-transitory computer readable storage medium storing one or more programs configured for execution by a computer system having one or more processors and memory storing one or more programs configured for execution by the one or more processors, the one or more programs comprising instructions for:
creating a calendar item scheduled at a time offset from a triggering event, wherein the triggering event comprises receiving one or more predefined signals from distinct sensors, including a first signal from a first sensor that identifies physical motion, and wherein the calendar item is associated with a user;
identifying the occurrence of the triggering event based on receiving the one or more predefined signals from the sensors;
updating the calendar item to specify a scheduled time that is computed as the time offset from the occurrence of the triggering event; and
notifying the user of the calendar item when the scheduled time is reached.

16. The computer readable storage medium of claim 15, wherein the one or more predefined signals comprise a plurality of predefined signals from a plurality of distinct sensors.

17. The computer readable storage medium of claim 16, wherein the plurality of distinct sensors includes a second sensor comprising a clock, and wherein a second signal from the second sensor indicates that a current time is within a predefined span of time.

18. The computer readable storage medium of claim 15, wherein the first signal from the first sensor indicates entry by the user into a predefined geographical region.

19. The computer readable storage medium of claim 15, wherein the first signal from the first sensor indicates arrival by the user at a predefined location.

20. The computer readable storage medium of claim 15, wherein the first sensor is an accelerometer and the first signal indicates movement of the accelerometer at least n times within a time span of m seconds, wherein n and m are positive integers.
